(19) United States
(12) Patent Application Publication
(10) Pub. No.: US 2019/0205796 A1
(43) Pub. Date: Jul. 4, 2019

(54) SYSTEM AND METHOD FOR OPTIMIZING ALLOCATION OF DIFFERENT CATEGORIES OF VEHICLES

(71) Applicant: ANI Technologies Private Limited, Bengaluru (IN)

(72) Inventors: Debarya Dutta, Bangalore (IN); Saket Ahuja, Bangalore (IN)

(21) Appl. No.: 16/059,759

(22) Filed: Aug. 9, 2018

(30) Foreign Application Priority Data
Dec. 29, 2017 (IN) 201741047191

(51) Int. Cl. G06Q 10/02; G06Q 50/30; G06Q 30/02; G08G 1/00; G06F 15/18

(52) U.S. Cl. CPC G06Q 10/02; G06Q 50/30; G06F 15/18; G08G 1/202; G06Q 30/0205

(57) ABSTRACT

A system and a method for allocating a proportion of high category vehicles for excess demands of low category vehicles is provided. The historical travel data for a first time period is extracted. Demands for a second time period are predicted based on the historical travel data. An error is determined based on the predicted demands and real-time demands. A real-time correction of the demands is executed at first and second time intervals. A real-time supply is predicted based on real-time location information of vehicles. A time to a booking of a supply is determined based on the real-time corrected demands, the real-time predicted supply, and an inter-arrival time of customers. The proportion of the high category vehicles is determined based on at least the determined time to booking of the supply, which are allocated to supply the excess demands associated with the low category vehicles in real-time.

### CROSS-RELATED APPLICATIONS

This application claims priority of Indian Application Serial No. 201741047191, filed Dec. 29, 2017, the contents of which are incorporated herein by reference.

### FIELD OF THE INVENTION

The present invention relates generally to a vehicle allocation system, and more particularly, to a method and a system for optimizing allocation of different categories of vehicles.

### BACKGROUND

Transport services, in particular on-demand cab services, generally have to optimize revenue that is directed towards balancing between demands from customers and vehicles available for transporting the customers. When the demand exceeds the available vehicles, the cab services cannot allocate the vehicles to the customers who are requesting for rides. Therefore, for the cab services, it is important to efficiently match the demand for the services with the supply of the vehicles.

Generally, in the cab services, different categories of vehicles exist. The different categories of vehicles are distinguished from each other based on a quality and a comfort level provided by the vehicles to the customers. Further, the different categories of vehicles have different ride costs i.e., the vehicles of the different categories are associated with different ride costs per unit of distance. Due to variations in the ride costs across the different categories of vehicles, the demands for the different categories of vehicles vary widely. For example, a ride cost of a luxury cab (e.g., Sedan cars) is higher than a ride cost of a non-luxury cab (e.g., hatchback cars). The distance travelled per trip for the different categories of vehicles vary across a wide range of geographic locations due to differences in the ride costs. For example, the customers belonging to a first geographic area prefer to travel by the vehicles belonging to a high level category. Further, the customers belonging to a second geographic area prefer to travel by the vehicles belonging to a low level category. Therefore, the demands for the vehicles of the high level category is high in the first geographic area compared to the demands for the same vehicles in the second geographic area.

The number of vehicles required for providing transportation services varies at different time intervals of a day. For example, the demands for the vehicles increase during night time of a monsoon season. Therefore, the number of vehicles required during the night time is higher compared to the number of vehicles required during the day time of the monsoon season. In another example, the demands for the vehicles can increase during mid-days of a summer season. Therefore, the number of vehicles required during the day time is higher compared to the number of vehicles required during the night time of the summer season. The combined effects of the varying demands based on time intervals and the varying demands based on the ride costs and the geographic area together form a complex real-time varying demand scenario in a travel industry. For example, the ride cost of the luxury cab is higher than the ride cost of the non-luxury cab, but an average trip time and an average distance travelled during the trip may be low for the luxury cab in comparison to an average trip time and an average distance travelled by a non-luxury cab in a day. Therefore, having a high number of luxury cars but with low demands can lead to a drop in a gross merchant value (GMV) of the cab services, which may incur losses to the transport service provider.

Further, the bookings of the vehicles are executed either on an individual basis or on a shared basis. On individual basis, an individual customer or a small group of customers traveling towards the same destination book a vehicle, whereas on shared basis, multiple customers share the vehicle to reach one or more destinations. The basis on which the customers prefer to travel further varies based on the demands for the different categories of the vehicles. Efficiency of the transport services can be determined by the time taken for a demand at a particular geographic location to be fulfilled by the supply of resources, namely by looking at the wait time for meeting the demand. With limited resources, it is far more important to match the varying demands across wide range of time intervals and geographic locations.

In light of the foregoing, there exists a need for a technical and more reliable solution that solves the above-mentioned problems and manages effective utilization of available resources in the transport services to meet the excess demands by customers. Further, it would be advantageous to have a system and a method that can improve the efficiency of the transport services, in general, and of cab services in particular by allocating unutilized categories of vehicles to meet the excess demands by the customers, thereby, ensuring increased comfort levels to the customers by providing vehicle services to the customers who are unable to book the vehicles of a particular category due to the excess demands.

### SUMMARY

Various embodiments of the present invention provide a method and a system for allocating a proportion of high category vehicles for demands of low category vehicles. The method includes one or more operations that are executed by circuitry of the system to allocate the proportion of high category vehicles for demands of the low category vehicles. The circuitry extracts historical travel data for a first time period over a communication network. The circuitry further predicts demands for a second time period. The demands are predicted based on the extracted historical travel data for at least one of vehicle category types or a geographical area. The vehicle category types indicates different categories of vehicles, such as the low or high category vehicles, for providing vehicle services to customers. The geographical area indicates a region in which the different categories of vehicles are being utilized for providing the vehicle services to the customers.

The circuitry further determines an error based on the predicted demands and real-time demands associated with the second time period. A real-time correction of the demands is executed at first and second time intervals. The real-time correction at the first time interval is executed based on the determined error. The real-time correction at the second time interval is executed based on an arrival rate of the real-time demands in one or more sub-time intervals of the second time interval. The circuitry is further configured to predict real-time supply based on real-time location information of one or more vehicles. The circuitry further determines a time to a booking of a supply based on the real-time corrected demands, the real-time predicted supply, and an inter-arrival time of the customers. The time to the booking of the supply is a time between a login time, a trip end time, or a trip canceled time, and a start time of the booking. The circuitry further determines the proportion of high category vehicles based on at least the determined time to the booking of the supply. The determined proportion of high category vehicles are allocated to supply excess demands associated with the low category vehicles in a real-time.

The historical travel data, extracted from a server over the communication network, includes at least one of source information, destination information, pick-up time, and drop-off time associated with the customers who travelled during the first time period. The circuitry is further configured to identify an algorithm from a set of algorithms by auctioning a portion of the extracted historical travel data. The demands for the second time period are predicated using the identified algorithm. The set of algorithms include at least an autoregressive exogenous (ARX) algorithm and an exponential smoothing algorithm. The circuitry further determines the inter-arrival time of the customers such that a difference between arrival times of the customers follows an exponential distribution. The proportion of high category vehicles is further determined based on a gross merchant value (GMV) and a trip time. The GMV is determined based on at least the real-time location information and the time to the booking of the supply. The trip time is determined based on the extracted historical travel data. The circuitry further allocates available vehicles of the high category vehicles in real-time to meet the excess demands associated with the low category vehicles.

Thus, the method and the system of the present invention provide an efficient and an effective usage of real-time data to guide the available vehicles of the high category vehicles for meeting the excess demands associated with the low category vehicles. Further, the method and the system of the present invention provide a choice to a vehicle service provider to ensure increased comfort levels of the customers by providing vehicle services to the customers who are unable to book the vehicles of a particular category due to the excess demands. Thus, the method and the system of the present invention may ensure increased footfalls of the customers for the vehicle services provided by the vehicle service provider, thereby, increasing overall utilization of various categories of vehicles.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice-versa.

FIG. 1 is a block diagram that illustrates an environment in which various embodiments of the present invention are practiced;

FIG. 2 is a block diagram that illustrates an application server of the environment of FIG. 1, in accordance with an embodiment of the present invention;

FIGS. 3A and 3B are block diagrams that illustrate an allocation of proportion of high category vehicles for demands of low category vehicles, in accordance with an embodiment of the present invention; and

FIG. 4 is a flow chart that illustrates a method for allocating a proportion of high category vehicles for demands of low category vehicles, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for optimizing allocations of different categories of vehicles to customers in a vehicle transit system. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A transportation service is an on-demand service in which a vehicle is provided to a customer to transit between source and destination locations provided by the customer. The vehicle is a means of transport that is deployed by a transport provider to provide the transportation service, such as the on-demand cab service, to the customer. For example, the vehicle is an automobile, a bus, a car, a bike, or the like. Hereinafter, various methods of optimizing allocations of different categories of vehicles to customers have been described that will become apparent to a person having ordinary skill in the relevant art.

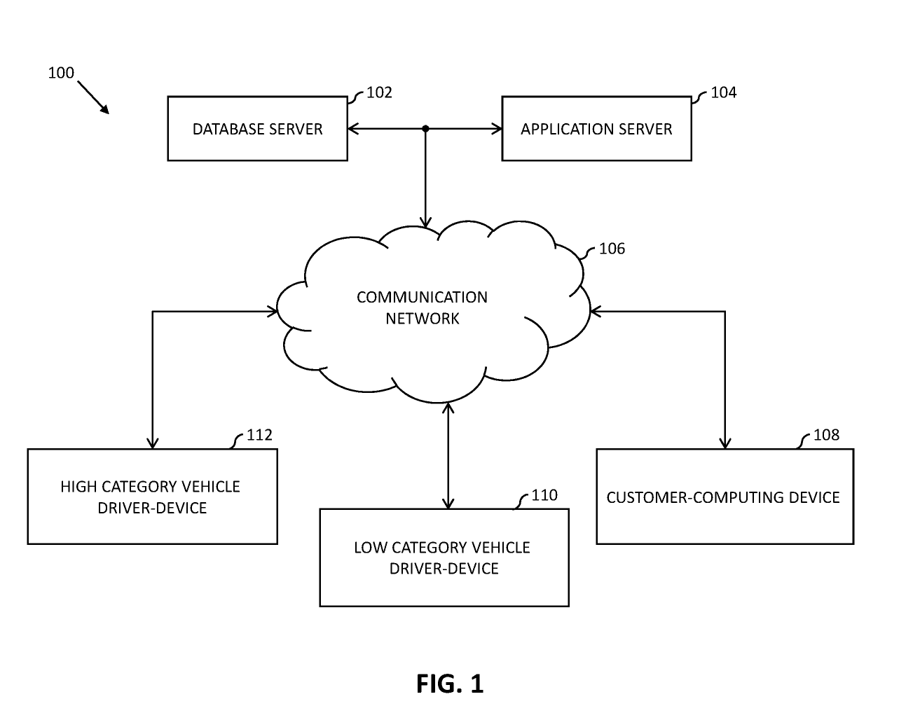

Referring now to FIG. 1, a block diagram that illustrates an environment 100 in which various embodiments of the present invention are practiced. The environment 100 includes a database server 102 and an application server 104 that are connected to each other by way of a communication network 106. Examples of the communication network 106 include, but are not limited to, a wireless fidelity (Wi-Fi) network, a light fidelity (Li-Fi) network, a satellite network, the Internet, a mobile network such as a cellular data network, a high speed packet access (HSPA) network, a wide area network (WAN), a local area network (LAN), or any combination thereof. The environment 100 further includes a customer-computing device 108, a low category vehicle driver device 110, and a high category vehicle driver device 112 that are connected to the database server 102 and the application server 104 by way of the communication network 106.

The database server 102 is a content management and storage server that includes a processor (not shown) and a memory (not shown) for managing and storing historical travel data of customers. The historical travel data of the customers includes travel data of rides that had been taken by the customers in the past. In an exemplary embodiment, the historical travel data may include a pick-up time, a drop-off time, a pick-up location, a drop-off location, a ride fare, and a travel distance of each of the rides that had been taken by each customer in the past. The processor of the database server 102 receives and stores the pick-up time, the drop-off time, the pick-up location, the drop-off location, the ride fare, and the travel distance of each of the rides in the memory. The database server 102 further manages and stores customer information of the customers (who had requested for the rides in the past) and driver information of drivers (who had been selected for providing vehicle services to the customers corresponding to their ride requests). In an exemplary embodiment, the customer information of a customer may include customer details, such as a customer name, a customer contact number, or a customer account of the customer registered with a transportation service. Similarly, the driver information of a driver may include driver details, such as a driver name, a driver vehicle, or a driver account of the driver registered with the transportation service. In an embodiment, the database server 102 receives a query from the application server 104 over the communication network 106 to obtain the historical travel data, the customer information, or the driver information. In response to the received query, the database server 102 retrieves and provides the historical travel data, the customer information, or the driver information to the application server 104 over the communication network 106. Examples of the database server 102 include, but are not limited to, a personal computer, a laptop, or a network of computer systems.

The application server 104 is a computing device, a software framework, or a combination thereof, that may provide a generalized approach to create the application server implementation. In an embodiment, the operation of the application server 104 may be dedicated to execution of procedures, such as, but not limited to, programs, routines, or scripts stored in a memory for supporting its applied applications. In an embodiment, the application server 104 processes the historical travel data extracted from the database server 102. Based on the processing of the extracted historical travel data, the application server 104 predicts demands for vehicle category types, a geographical area, or a combination thereof. The vehicle category types includes different categories of vehicles, such as low and high category vehicles, for providing the vehicle services to the customers. The geographical area is a region in which the different categories of vehicles are being utilized for providing the vehicle services to the customers.

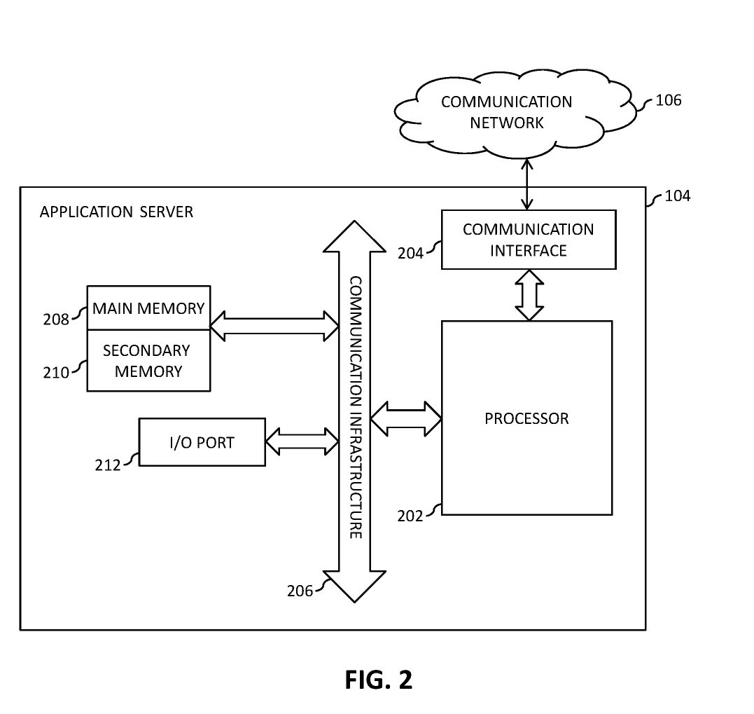

Further, in an embodiment, the application server 104 may be configured to execute one of a set of algorithms including an autoregressive exogenous (ARX) algorithm and an exponential smoothing algorithm for predicting the demands. Further, the application server 104 determines an error based on the predicted demands and real-time demands. Further, in an embodiment, the application server 104 executes a real-time correction of the demands. The real-time correction at a first time interval is executed based on the determined error. The application server 104 further predicts real-time supply based on real-time location information of vehicles. Further, the application server 104 determines a time to a booking of a supply. The time to the booking of the supply is a time between a login time, a logout time, a trip end time, or a trip canceled time, and a start time of the booking. The time to the booking of the supply is determined based on the real-time corrected demands, the real-time predicted supply, and an inter-arrival time of the customers. Further, the application server 104 determines the proportion of high category vehicles based on at least the determined time to the booking of the supply in a real-time. The application server 104 may be realized through various web-based technologies such as, but not limited to, a Java web-framework, a .NET framework, a PHP framework, or any other web-application framework. Examples of the application server 104 include, but are not limited to, a personal computer, a laptop, or a network of computer systems. The various operations of the application server 104 have been described in conjunction with FIGS. 2, 3A, 3B, and 4.

The customer-computing device 108 is a computing device that is used by the customer to perform one or more activities. For example, the customer uses the customer-computing device 108 to schedule a ride between source and destination locations. To schedule the ride, the customer uses the customer-computing device 108 to transmit a ride request for the ride by means of a service application installed on the customer-computing device 108. The ride request includes ride-related information, such as a pick-up location, a drop-off location, a waiting time, a vehicle type, or other service-related details and preferences. In a scenario when the pick-up location of the customer is the same as the source location, the customer may not provide the pick-up location. In such scenario, the pick-up location may be automatically captured by the application server 104 based on Global Positioning System (GPS) information transmitted by the customer-computing device 108 over the communication network 106. However, if the pick-up location is different from the captured source location, the customer may provide the pick-up location. The various modes of the input used by the customer may include a touch-based input, a text-based input, a voice-based input, a gesture-based input, or a combination thereof. Based on a confirmation of the ride request by the customer, the customer-computing device 108 transmits the ride request to the application server 104 via the communication network 106. Examples of the customer-computing device 108 include, but are not limited to, a personal computer, a laptop, a smartphone, a tablet computer, and the like.

The low category vehicle driver-device 110 (hereinafter, the driver device 110) is a computing device that is used by the driver of a low category vehicle to perform one or more activities. For example, the driver uses the driver device 110 to view an upcoming ride request from the customer. The low category vehicle is a vehicle for which a ride fare is less than a defined threshold value. For example, the ride fare of the low category vehicle is higher than the ride fare of a high category vehicle. Further, a comfort level in the low category vehicle is lower in comparison to a comfort level of the high category vehicle. In one example, sedan and hatchback cars may be used as low category vehicles. The driver of the low category vehicle further uses the driver device 110 to view a route between the pick-up and drop-off locations provided by the application server 104 over the communication network 106. The various modes of the input used by the driver may include a touch-based input, a text-based input, a voice-based input, a gesture-based input, or a combination thereof. In an exemplary embodiment, the driver device 110 may be a vehicle head unit. In another exemplary embodiment, the driver device 110 may be an external communication device, such as a smartphone, a PDA, a tablet computer, a laptop, or any other portable communication device, that is placed inside the low category vehicle.

The high category vehicle driver device 112 (hereinafter, the driver device 112) is a computing device that is used by the driver of the high category vehicle to perform one or more activities. For example, the driver uses the driver device 112 to view an upcoming ride request from the customer. The high category vehicle is a vehicle for which a ride fare is higher than a defined threshold value. For example, the ride fare of the high category vehicle is higher than the ride fare of the low category vehicle. In one example, luxury and semi-luxury sedan cars are used as high category vehicles. The driver of the high category vehicle further uses the driver device 112 to view a route between the pick-up and drop-off locations provided by the application server 104 over the communication network 106. The various modes of the input used by the driver may include a touch-based input, a text-based input, a voice-based input, a gesture-based input, or a combination thereof. In an exemplary embodiment, the driver device 112 may be a vehicle head unit. In another exemplary embodiment, the driver device 112 may be an external communication device, such as a smartphone, a PDA, a tablet computer, a laptop, or any other portable communication device, that is placed inside the high category vehicle.

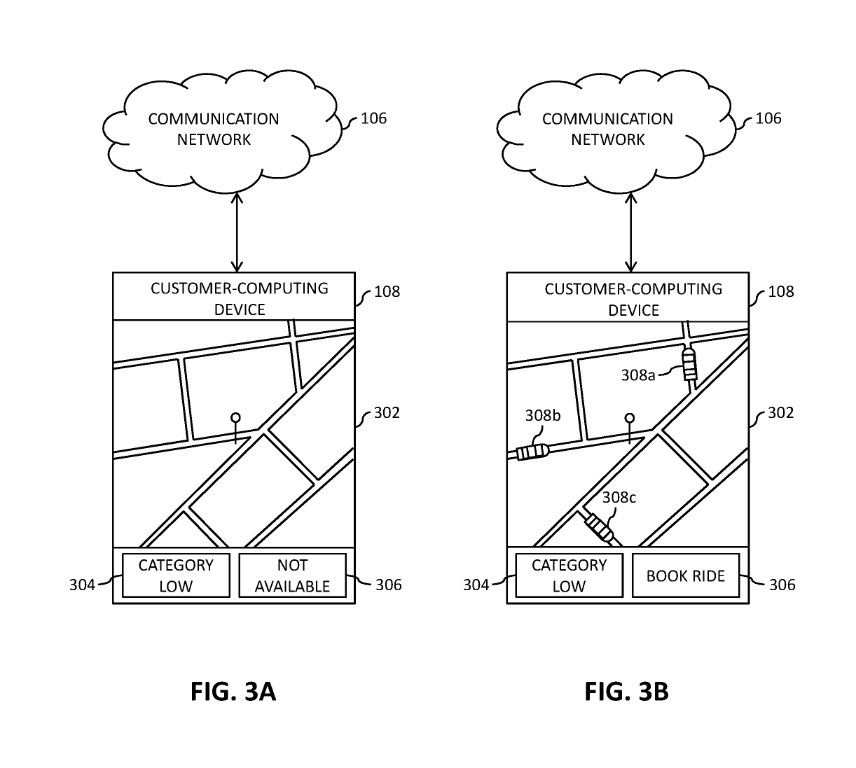

Referring now to FIG. 2, a block diagram that illustrates the application server 104 of the environment 100 of FIG. 1 is shown, in accordance with an embodiment of the present invention. An embodiment of the present invention, or portions thereof, may be implemented as computer readable code on the application server 104. In one example, the application server 104 may be implemented using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A and 3B. The application server 104 includes a processor 202, a communication interface 204, a communication infrastructure 206, a main memory 208, a secondary memory 210, and an input/output (I/O) port 212.

The processor 202 includes suitable logic, circuitry, and/or interfaces that are operable to execute one or more instructions stored in at least one of the main and secondary memories 208 and 210 to perform one or more operations. The processor 202 may be a special purpose or a general purpose processing device. The processor 202 may be a single processor, multiple processors, or combinations thereof. The processor 202 may have one or more processor “cores”. Further, the processor 202 may be connected to the communication infrastructure 206, such as a bus, a bridge, a message queue, the communication network 106, multi-core message-passing scheme, or the like. Examples of the processor 202 include an application-specific integrated circuit (ASIC) processor, a reduced instruction set computing (RISC) processor, a complex instruction set computing (CISC) processor, a field-programmable gate array (FPGA), and the like. The processor 202 may be connected to the communication interface 204 for receiving and transmitting information (e.g., the historical travel data, the customer information, the driver information, the ride request, the targeted content, or the like) from the database server 102, the consumer-computing device 108, or the drive devices 110 and 112 over the communication networks 106.

The communication interface 204 includes suitable logic, circuitry, and/or interfaces that are operable to execute one or more instructions stored in at least one of the main and secondary memories 208 and 210 to perform one or more operations. The communication interface 204 may be configured to communicate with the communication network 106 to receive and transmit the information from the database server 102, the consumer-computing device 108, and the driver devices 110 and 112 that are communicatively coupled to the application server 104. Examples of the communication interface 204 may include a modem, a network interface, i.e., an Ethernet card, a communications port, and the like. The information transferred via the communication interface 204 may be signals, such as electronic, electromagnetic, optical, or other signals as will be apparent to a person skilled in the art. The signals may travel via a communications channel, such as the communication network 106, which may be configured to transmit the signals to devices that are communicatively coupled to the application server 104. Examples of the communication channel may include, but are not limited to, cable, fiber optics, a phone line, a cellular phone link, a radio frequency link, a wireless link, and the like.

The communication infrastructure 206 includes suitable logic, circuitry, and/or interfaces that are operable to execute one or more instructions stored in at least one of the main and secondary memories 208 and 210 to perform one or more operations. The communication infrastructure 206 may be a bus, a bridge, a message queue, multi-core message-passing scheme, or the like. Further, the processor 202 may be connected to the communication infrastructure 206. The processor 202, the main memory 208, the secondary memory 210, and the I/O port 212 may communicate with each other by way of the communication infrastructure 206.

The main memory 208 includes suitable logic, circuitry, and/or interfaces to store the one or more instructions that are executed by the processor 202 to perform the one or more operations. The main memory 208 may further store one or more algorithms, procedures, codes, and the like that are executed by the processor 202 to perform the one or more operations. For example, the processor 202 may execute the one or more instructions, algorithms, procedures, codes, and the like, stored in the main memory 208, to process the extracted historical travel data, predict the demands, determine the error based on the predicted demands, execute the real-time correction of the demands based on the determined error, predict the real-time supply, and determine the time to the booking of the supply. Examples of the main memory 208 include a random access memory (RAM), a read-only memory (ROM), a programmable ROM (PROM), an erasable PROM (EPROM), a Hard Disk Drive (HDD), and a Secure Digital (SD) card, and the like. In an embodiment, the main memory 208 is connected the secondary memory 210 for storing additional information. The secondary memory 210 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The I/O port 212 includes suitable logic, circuitry, and/or interfaces that are operable to execute one or more instructions stored in at least one of the main and secondary memories 208 and 210 to perform one or more operations. The I/O port 212 may include various input and output devices that are configured to operate under the control of the processor 202 by way of the communication infrastructure 206. Examples of the input devices may include a keyboard, a mouse, a joystick, a touchscreen, a microphone, and the like. Examples of the output devices may include a display screen, a speaker, headphones, and the like. Examples of the I/O port 212 include a universal serial bus (USB) port, an Ethernet port, a real or virtual keypad, a mouse, a stylus, and the like.

Referring now to FIGS. 3A and 3B, block diagrams that illustrate the allocation of the proportion of high category vehicles for demands of the low category vehicles are shown, in accordance an embodiment of the present invention. An exemplary environment of FIG. 3A includes the communication network 106 and the customer-computing device 108. The customer-computing device 108 further includes an I/O display 302 that presents a category section 304 for displaying a category of a requested vehicle. The I/O display 302 further presents an availability section 306 for displaying an availability of the requested vehicle for the requested category. The requested vehicle category is at least one of the low category vehicles or the high category vehicles. The availability section 306 displays the availability of the vehicles and an option to book the requested vehicle when the vehicles are available for the ride. The I/O display 302 further presents a road network associated with the pick-up location of the customer, and displays the pick-up location of the customer and available vehicles for the ride requested by the customer.

In the exemplary scenario of FIG. 3A, the customer requests for the low category vehicle for the ride at a first time of a day. Due to the excess demands for the low category vehicles that are currently operating to transport the customers of ongoing ride requests, the low category vehicle is not available for the requested ride by the customer. In such a scenario, the I/O display 302 displays a message corresponding to the availability of the low category vehicles as “NOT AVAILABLE” in the availability section 306, as shown. However, the high category vehicles may be available. In such a scenario, even if the high category vehicles are available, the vehicle services are not provided to the customer, and hence, results into loss of services and under-utilization of the available resources.

An exemplary environment of FIG. 3B illustrates the allocation of the high category vehicles for the excess demands of the low category vehicles. The exemplary environment of FIG. 3B includes the communication network 106 and the customer-computing device 108. The customer-computing device 108 includes the I/O display 302 that displays the category section 304 and the availability section 306. In an exemplary scenario, the customer requests for the low category vehicle for the ride at the first time of the day. Due to the excess demands for the low category vehicles that are operating to transport the customers of the ongoing ride requests, the low category vehicle is not available for the requested ride by the customer. The application server 104 predicts the excess demands based on the historical travel data and the real-time demand and supply data. In the event of the excess demands for the low category vehicles, the application server 104 checks for the availability of the high category vehicles. When the application server 104 determines that there are the proportion of high category vehicles that are not being utilized due to less demands for the high category vehicles, the application server 104 allocates the proportion of high category vehicles for the excess demands of the low category vehicles. In such a scenario, the customer may view the high category vehicles, such as the vehicles 308a, 308b, and 308c, which are available for booking the ride at the fare of the low category vehicles. Based on the availability of the high category vehicles, the I/O display 302 displays a message corresponding to the availability of the high category vehicles as “BOOK RIDE” in the availability section 306, as shown. The customer may select the “BOOK RIDE” option in the availability section 306 to confirm the booking for the ride. Thus, the proportion of high category vehicles that could have remained unutilized are efficiently utilized that ensures earnings for the drivers of the high category vehicles and customer satisfaction for the customers. Furthermore, the engagement of the customers with the transportation service is also enhanced.

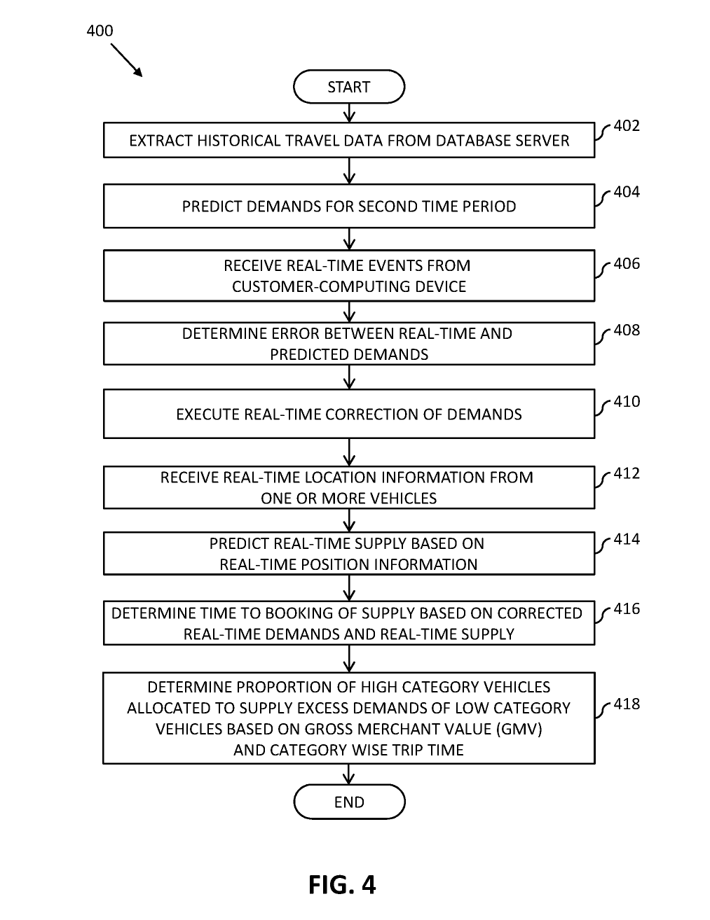

Referring now to FIG. 4, a flow chart 400 that illustrates a method for allocating the proportion of high category vehicles for demands of the low category vehicles is shown, in accordance with an embodiment of the present invention.

At step 402, the historical travel data of the customers is extracted. The processor 202 extracts the historical travel data for the first time period from the database server 102 over the communication network 106. The communication interface 204 receives the extracted historical travel data from the database server 102 over the communication network 106, and provides the extracted historical travel data to the processor 202 by way of the communication infrastructure 206. The extracted historical travel data includes at least one of the travel-related data of the rides that had been taken by the customers in the past. For example, the historical travel data may include at least one of the pick-up time, the drop-off time, the pick-up location, the drop-off location, the ride fare, and the travel distance of each of the rides by the customers. The processor 202 stores the extracted historical travel data for the first time period in at least one of the main or secondary memory 208 or 210.

At step 404, the demands are predicted for the second time period. The processor 202 predicts the demands for the second time period for at least one of the vehicle category types or the geographical area based on the extracted historical travel data. The demands for the second time period are predicted by means of the algorithm identified from the set of algorithms. In an embodiment, the processor 202 auctions a portion of the extracted historical travel data to identify the algorithm from the set of algorithms including at least the ARX algorithm and the exponential smoothing algorithm. In an exemplary embodiment, the processor 202 extracts the historical travel data for “24 hour” time period (also referred to as the first time period). The processor 202 receives the historical travel data and auctions the portion of the historical travel data to identify the algorithm from the set of algorithms. In one example, the processor 202 auctions “10 percent” of the historical travel data using each of the set of algorithms, and whichever algorithm from the set of algorithms performs best (for example, in terms of an accuracy of the predicted demands) with the “10 percent” of auctioned historical data may be identified as the algorithm for predicting the demands for the second time period. For example, with the “10 percent” of the extracted historical travel data, the accuracy of the predicted demands for the “24 hours” time period by the ARX algorithm is more than the accuracy of the predicted demands for the “24 hours” time period by the exponential smoothing algorithm. In such a scenario, the ARX algorithm is identified for predicting the demands for the second time period based on the extracted historical travel data.

At step 406, real-time events are received from the customer-computing device 108. The processor 202 receives the real-time events by means of the installed application on the customer-computing device 108 of each of the customers. The real-time events may be real-time demands for the vehicle services that are being requested by the customers by means of the installed application on their respective computing devices, such as the customer-computing device 108.

At step 408, the error between the real-time and predicted demands is determined. The processor 202 determines the error between the real-time and predicted demands. At step 410, the real-time corrections of the demands is executed. The processor 202 executes the real-time corrections of the demands at a regular interval of time, for example, after every first and second time intervals. In an embodiment, the real-time correction at the first time interval is executed based on the determined error. In an embodiment, the real-time correction at the second time interval is executed based on an arrival rate of the real-time demands in one or more sub-time intervals of the second time interval. The arrival rate of the real-time demands is a rate at which the demands are initiated by the customers in the real-time. The execution of the real-time corrections at the first and second time intervals ensures minimization of errors between the predicted demands and the real-time demands. In one example, the processor 202 executes the real-time correction at every “30 minutes” based on the determined error. Further, the processor 202 executes the real-time correction at every “5 minutes” based on the arrival rate of the real-time demands. In one example, the arrival rate of the real-time demands follows an exponential distribution. The processor 202 executes the real-time corrections at every “5 minutes” based on the arrival rate of the real-time demands in the “5 minute” interval. Further, at every “30 minutes”, the processor 202 executes the real-time corrections based on the arrival rate of the real-time demands in the “30 minute” interval.

At step 412, the real-time location information is received from devices of the vehicles. The communication interface 204 receives the real-time location information from the devices, such as the driver devices 110 and 112, over the communication network 106. The communication interface 204 provides the real-time location information of the vehicles, such as the low category and high category vehicles, to the processor 202 by way of the communication infrastructure 206.

At step 414, the real-time supply is predicted based on the real-time location information. The processor 202 predicts the real-time supply based on the real-time location information of the vehicles. For example, the processor 202 predicts the real-time supply, when the real-time location information of the vehicles indicates that the vehicles are currently operating to transport the customers to their drop-off locations.

At step 416, the time to the booking of the supply is determined. The processor 202 determines the time to the booking of the supply based on the corrected real-time demands, the predicted real-time supply, and the exponential assumptions on the arrival time of the customers. The time to the booking of the supply refers to the time between the login time, the logout time, the trip end time, or the trip cancelled time, and a start time of the booking requests. The exponential assumptions on the arrival time means that a time difference of arrival time follows an exponential distribution. Further, the processor 202 determines a GMV based on at least the real-time location information and the time to the booking of the supply. The processor 202 further determines a category-wise trip time. The category-wise trip time is a mean of trip times associated with the historical travel data corresponding to the high and low categories of vehicles.

At step 418, the proportion of high category vehicles to supply the excess demands of the low category vehicles is determined. In an embodiment, the processor 202 determines the proportion of high category vehicles based on the determined time to the booking of the supply, the GMV, and the category-wise trip time. The processor 202 determines the proportion of high category vehicles that are allocated to supply the excess demands of the low category vehicles based on the maximization of the bookings in the real-time. In an embodiment, using the category-wise trip time and the GMV, the supply of the high category vehicles is stopped from matching with the demands of the low category vehicles. The trip time usually varies category wise, so a high category booking would usually result in a shorter trip than a low category booking, hence, a mean trip time of the high category vehicles is less than a mean trip time of the low category vehicles. Further, using the GMV, the trip time, and the time to the booking of the supply, the proportion of high category vehicles is optimized, so that the proportion of high category vehicles can be utilized for the excess demands of the low category vehicles.

Hence, the proportion of the high category vehicles, which are not being utilized for the providing the vehicle services, are identified, and thereafter, are allocated to the customers for supplying the excess demands associated with the low category vehicles. Thus, the excess demands of the low category vehicles are addressed using the available high category vehicles, which may have remained unutilized due to shortage of the demands for the high category vehicles, thereby, ensuring optimal utilization of the available vehicle resources. Such optimal utilization of the available vehicle resources further ensures enhanced customer engagement with the service provider. The enhanced customer engagement may ensure long-term association of the customers with the service provider. Further, the enhanced customer engagement may attract other customers for using the vehicles services provided by the service provider.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 202 and a memory such as the main memory 208 and the secondary memory 210 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for allocating the proportion of the high category vehicles for the excess demands of the low category vehicles. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for allocating a proportion of high category vehicles for demands of low category vehicles, the method comprising:
extracting, by a circuitry, historical travel data for a first time period over a communication network;
predicting, by the circuitry, demands for a second time period for at least one of vehicle category types or a geographical area based on the extracted historical travel data;
determining, by the circuitry, an error based on the predicted demands and real-time demands associated with the second time period;
executing, by the circuitry, a real-time correction of the demands at first and second time intervals, wherein the real-time correction at the first time interval is executed based on the determined error, and wherein the real-time correction at the second time interval is executed based on an arrival rate of the real-time demands in one or more sub-time intervals of the second time interval;
predicting, by the circuitry, real-time supply based on real-time location information of one or more vehicles;
determining, by the circuitry, a time to a booking of a supply based on the real-time corrected demands, the real-time predicted supply, and an inter-arrival time of customers;
determining, by the circuitry, the proportion of the high category vehicles based on at least the determined time to the booking of the supply; and
allocating the determined proportion of the high category vehicles to the customers to supply excess demands associated with the low category vehicles in real-time.

2. The method of claim 1, wherein the historical travel data is extracted from a server over the communication network, and wherein the historical travel data includes at least one of source information, destination information, pick-up time, and drop-off time associated with the customers who travelled during the first time period.

3. The method of claim 1, further comprising identifying, by the circuitry, an algorithm from a plurality of algorithms by means of auctioning a portion of the historical travel data, wherein the demands for the second time period are predicated by means of the identified algorithm.

4. The method of claim 3, wherein the plurality of prediction algorithms include at least an autoregressive exogenous (ARX) algorithm and exponential smoothing algorithm.

5. The method of claim 1, further comprising determining, by the circuitry, the inter-arrival time of the customers such that a difference between arrival times of the customers follows an exponential distribution.

6. The method of claim 1, wherein the proportion of the high category vehicles is further determined based on a gross merchant value (GMV) and a trip time, wherein the GMV is determined based on at least the real-time location information and the time to the booking of the supply, and wherein the trip time is determined based on the historical travel data.

7. A system for allocating a proportion of high category vehicles for demands of low category vehicles, the system comprising:
a circuitry configured to:
extract over a communication network, historical travel data for a first time period;
predict demands for a second time period for at least one of vehicle category types or a geographical area based on the extracted historical travel data;
determine an error based on the predicted demands and real-time demands associated with the second time period;
execute a real-time correction of the demands at first and second time intervals, wherein the real-time correction at the first time interval is executed based on the determined error, and wherein the real-time correction at the second time interval is executed based on an arrival rate of the real-time demands in one or more sub-time intervals of the second time interval;
predict real-time supply based on real-time location information of one or more vehicles;
determine a time to a booking of a supply based on the real-time corrected demands, the real-time predicted supply, and an inter-arrival time of customers;
determine the proportion of the high category vehicles based on at least the determined time to the booking of the supply; and
allocate the determined proportion of the high category vehicles to the customers to supply excess demands associated with the low category vehicles in real-time.

8. The system of claim 7, wherein the circuitry is further configured to extract the historical travel data from a server over the communication network, and wherein the historical travel data includes at least source information, destination information, pick-up time, and drop-off time associated with the customers who travelled during the first time period.

9. The system of claim 7, wherein the circuitry is further configured to identify an algorithm from a plurality of algorithms by means of auctioning a portion of the historical travel data, wherein the circuitry predicts demands for the second time period by means of the identified algorithm.

10. The system of claim 9, wherein the plurality of prediction algorithms include at least an autoregressive exogenous (ARX) algorithm and exponential smoothing algorithm.

11. The system of claim 7, wherein the circuitry is further configured to determine the inter-arrival time of the customers such that a difference between arrival times of the customers follows an exponential distribution.

12. The system of claim 7, wherein the circuitry is further configured to determine the proportion of the high category vehicles based on a gross merchant value (GMV) and a trip time, wherein the GMV is determined based on at least the real-time location information and the time to the booking of the supply, and wherein the trip time is determined based on the historical travel data.
